(19) United States
(12) Patent Application Publication
(10) Pub. No.: US 2014/0170237 A1
(43) Pub. Date: Jun. 19, 2014

(54) ANTIMICROBIAL COMPOSITIONS CONTAINING MIXTURES OF FATTY AND HYDROXYL CARBOXYLIC ACIDS

(71) Applicant: Yueh Wang, Arlington Heights, IL (US)

(72) Inventor: Yueh Wang, Arlington Heights, IL (US)

(21) Appl. No.: 14/105,810

(22) Filed: Dec. 13, 2013

Related U.S. Application Data
(60) Provisional application No. 61/797,724, filed on Dec. 14, 2012.

(51) Int. Cl. A01N 59/26; A01N 25/04; A01N 37/02

(52) U.S. Cl. CPC A01N 59/26; A01N 37/02; A01N 25/04
USPC 424/605

(57) ABSTRACT

The application is directed to cold temperature stable micro emulsion concentrate compositions comprising from about 5 to about 15% by weight of an alkyl fatty acids mixture, wherein the fatty acids mixture consists of C8 fatty acids and/or C9 fatty acids, C10 fatty acids and/or C12 fatty acids; from about 20 to 60% by weight (+)-lactic acid and/or from about 0 to about 40% by weight phosphoric acid; and from about 20 to about 40% by weight C8 to C16 mono- and/or di-alkyldiphenyloxide disulfonate (ADPODS) surfactants. The application is also directed to ready to use products comprising from about 0.02 to 0.2% by weight C9 fatty acids or C9-C10-C12 fatty acids, 0.5 to 2% by weight L(+)-lactic acid, and from about 0.5 to about 4% by weight of C8 to C16 mono- and/or di-alkyldiphenyloxide disulfonate (ADPODS) or fatty alcohol ethoxylate surfactants.

### CROSS REFERENCE TO RELATED APPLICATIONS

This application claims the benefit of U.S. Provisional Application Ser. No. 61/797,724 filed Dec. 14, 2012. The entire teaching of this application is incorporated herein by reference.

### FIELD OF THE INVENTION

The invention relates to bactericidal, fungicidal and virucidal micro-emulsion concentrate (“MEC”) compositions comprising a synergistic mixture of octanoic (C8) and/or nonanoic (C9), decanoic (C10), and dodecanoic (C12) fatty acids, L(+)-lactic acid and/or phosphoric acid, and C8 to C16 mono- and/or di-alkyldiphenyloxide disulfonate (ADPODS) surfactants.

### BACKGROUND OF THE INVENTION

In view of food safety and public health concerns associated with food-borne diseases, human and animal viruses, antibiotic-resistant pathogens and bioterrorism (such as Bacillus anthracis), there are market needs for safe, effective, broad-spectrum and non-resistant antimicrobial products to battle against human and animal pathogens as well as bio-weapons. A new mode of action is also needed for bactericide or fungicide resistance management. In addition, it is very desirable to have an antimicrobial product with no maximum residue limit (“MRL”) for food safety and environmental protection.

Previously, Applicant discovered that soluble C8 fatty acids and C10 fatty acids mixtures (octanoic and decanoic acids) derived from coconut oil were potent bactericides against both gram positive (S. aureus) and gram negative (E. coli) organisms (see U.S. Pat. No. 4,404,040). As a result, a non-rinse acid sanitizer called Mandate™ containing food-grade 4.8% C8 and 3.2% C10 fatty acids in conjunction with citric and phosphoric acids received US Food and Drug Administration (“FDA”) approval for sanitizing and cleaning food processing equipments, for use in hospitals and institutions, and for animal housing applications. All of the active and inert ingredients in the Mandate™ formulation are exempted for tolerance when used in food-contact surface, as published in US FDA 21 CFR §178.1010 or US EPA 40 CFR §180.940. The Mandate™ formulation, however, showed phase separation (oil) of the C8 and C10 fatty acids in cold storage. A further limitation of this formulation is that it is less active at 4 degrees Celsius water temperature because the C8 and C10 fatty acids crystallize.

A modified Mandate™ formulation was then introduced by West Agro which includes 10% propanoic acid (C3) to solubilize the 3% C9 (nonanoic acid) and the 3% C10 fatty acids in the concentrated formulation for improving cold storage stability (see U.S. Pat. No. 5,391,379). However, there was no indication that propanoic acid could prevent the crystallization of C9 or C10 free fatty acids in cold water dilutions. Another limitation of this formulation is that it has a pungent rancid odor because it contains propanoic acid.

Recently, Mandate™ Plus was commercialized by Ecolab® which contains 6.49% C9 and 1.09% C10 fatty acids plus acetic (C2), nitric and phosphoric acids (see U.S. Pat. No. 6,472,358 B1). It was claimed that the use of acetic and nitric acids improved the cold temperature stability. However, there was no evidence of the activity of Mandate™ Plus in cold water. Further, C2 is a short-chain carboxylic acid that is a volatile chemical that gives off a pungent and unpleasant odor. This odor is present in the concentrated formulations and in the diluted formulations. The pungent odor impacts the users' health and may violate volatile organic compound (“VOC”) regulations. In addition, nitric acid is unsafe to handle because it is a highly corrosive strong mineral acid. Yet another limitation of this formulation is that the phosphoric and nitric acid run-off can cause water pollution and damage the environment.

Accordingly, there is a need for a new antimicrobial composition which utilizes renewable fatty and hydroxyl carboxylic acid mixtures in water-dilutable MEC formulations that have good cold storage stability, low odor, and are safe to handle and use. The ME dilution or Ready To Use (“RTU”) formulations based on these MEC formulations should possess broad-spectrum activity against bacteria, fungi and viruses with high efficacy and have fast kill rates at water temperatures from about 4 to about 25 degrees Celsius. The ME dilution or RTU formulation should also be effective in hard and organic-load waters. The improved formulations should also have no MRL in food, fruit and vegetable surfaces, be low VOC, and be environmentally safe.

### SUMMARY OF THE INVENTION

Applicant discovered formulations containing C8 fatty acids and/or C9 fatty acids, C10 fatty acids and/or C12 fatty acids that are cold storage stable, stable when diluted with cold water, environmentally safe, low VOC, have no MRL, are highly effective against bacteria, fungi, and viruses, and safe for the end user.

In one aspect, the invention is directed to cold temperature stable micro emulsion concentrate compositions comprising from about 5 to about 15% of an alkyl fatty acids mixture, wherein the fatty acids mixture consists of from about 20 to about 80% C8 fatty acids, from about 20 to about 80% C9 fatty acids, from about 10 to about 50% C10 fatty acids, and from about 0 to about 30% C12 fatty acids; from about 20 to 60% L(+)-lactic acid and/or from about 0 to about 40% phosphoric acid; and from about 20 to about 40% C8 to C16 mono- and/or di-alkyldiphenyloxide disulfonate (ADPODS) surfactants, wherein all of percentages are by weight of the composition.

In a further aspect, the invention is directed to cold temperature stable micro emulsion concentrate compositions comprising from about 5 to about 15% of an alkyl fatty acids mixture, wherein the fatty acids mixture consists of from about 20 to about 80% C9 fatty acids, from about 10 to about 50% C10 fatty acids, and from about 10 to about 30% C12 fatty acids; from about 20 to 60% L(+)-lactic acid and/or from about 0 to about 40% phosphoric acid; and from about 20 to about 40% C8 to C16 mono- and/or di-alkyldiphenyloxide disulfonate (ADPODS) surfactants, wherein all of percentages are by weight of the composition.

In a third aspect, the invention is directed to ready to use antibiotic cleaners comprising from about 0.02 to 0.2% C9 fatty acids or C9-C10-C12 fatty acids, 0.5 to 2% L(+)-lactic acid, and from about 0.5 to about 4% C8 to C16 mono- and/or di-alkyldiphenyloxide disulfonate (ADPODS) or fatty alcohol ethoxylate surfactants, wherein all of percentages are by weight of the composition.

### DETAILED DESCRIPTION

Applicant unexpectedly discovered a way to overcome the problems of the prior art formulations by combining specific fatty acids at specific concentrations. C8-C9-C10 fatty acids and C9-C10-C12 fatty acids combinations will remain liquid under cold temperatures even under long storage conditions (see Example 1 below).

Applicant also found that the fatty acids mixtures of the present invention were stable during storage and during dilution with water when formulated with C8 to C16 mono- and/or di-alkyldiphenyloxide disulfonate (ADPODS) and L-lactic acid or phosphoric acid (see Example 2 below).

Applicant unexpectedly found that the storage stable formulations of the present invention were also very potent. The formulations had high bactericidal, fungicidal and virucidal properties even after been stored and diluted (see Examples 3, 5, and 6 below).

The formulations have low toxicity, as well. A formulation of the present invention was shown to have low toxicity during standardized rat acute testing and rabbit dermal studies (see Example 4 below). The formulations also do not have pungent odors that might harm users' respiratory systems.

Finally, Applicant provides herein ready to use micro emulsion formulations that are stable and have high kill rates of pests. This is illustrated by Example 8 below.

The percentages of the components in the compositions in the embodiments below are listed by weight percentage.

In one embodiment, the invention is directed to cold temperature stable micro emulsion concentrate composition comprising from about 5 to about 15% of an alkyl fatty acids mixture, wherein the fatty acids mixture consists of from about 20 to about 80% C8 fatty acids, from about 20 to about 80% C9 fatty acids, from about 10 to about 50% C10 fatty acids, and from about 0 to about 30% C12 fatty acids; from about 20 to 60% L(+)-lactic acid and/or from about 0 to about 40% phosphoric acid; and from about 20 to about 40% C8 to C16 mono- and/or di-alkyldiphenyloxide disulfonate (ADPODS) surfactants.

In another embodiment, the invention is directed to compositions wherein the fatty acids mixture consists of from about 20 to about 40% C8 fatty acids, from about 40 to about 60% C9 fatty acids, from about 10 to about 30% C10 fatty acids, and from about 0 to about 20% C12 fatty acids.

In an embodiment, the composition comprises from about 8 to about 12% of the fatty acids mixture. Preferably, the composition comprises 10% or 12% of the fatty acids mixture.

In a further embodiment, the composition contains from about 20 to about 50% L(+)-lactic acid. Preferably, the composition comprises 20% or 50% L(+)-lactic acid. L-lactic acid is very effective as a calcium chelating agent.

In an embodiment, the composition contains from about 30 to about 40% phosphoric acid. Preferably, the composition contains from about 30 to about 35% phosphoric acid. In another preferred embodiment, the composition contains 0% phosphoric acid.

In another embodiment, the composition contains from about 30 to about 40% ADPODS. Preferably, the composition contains from about 30 to about 35% ADPODS.

In a preferred embodiment, the composition contains from about 10% to about 12% of the fatty acids mixture, about 20% L(+)-lactic acid, about 35% phosphoric acid, and about 35% ADPODS. In a more preferred embodiment, this composition contains a fatty acids mixture that is about 30% C8 fatty acids, about 50% C9 fatty acids, and about 20% C10 fatty acids.

In an embodiment, the compositions of the present invention can be diluted with water by the end user to form a product that is ready to use for an intended purpose.

In another embodiment, the invention is directed to a cold temperature stable micro emulsion concentrate composition comprising from about 5 to about 15% of an alkyl fatty acids mixture, wherein the fatty acids mixture consists of from about 20 to about 80% C9 fatty acids, from about 10 to about 50% C10 fatty acids, and from about 10 to about 30% C12 fatty acids; from about 20 to 60% L(+)-lactic acid or from about 0 to about 40% phosphoric acid; and from about 20 to about 40% C8 to C16 mono- and/or di-alkyldiphenyloxide disulfonate (ADPODS) surfactants.

In a further embodiment, the fatty acids mixture in the compositions of the invention contains from about 50 to about 60% C9 fatty acids, from about 20 to about 30% C10 fatty acids, and from about 10 to about 20% C12 fatty acids.

In an embodiment, the compositions contain from about 8 to about 12% fatty acids mixture. Preferably, the compositions contain about 10% or 12% fatty acids mixture.

In a preferred embodiment, the composition contains from about 20 to about 50% L(+)-lactic acid. Preferably, the compositions contain about 20% or about 50% L(+)-lactic acid.

In another embodiment, the composition contains from about 30 to about 40% phosphoric acid. Preferably, the composition contains from about 30 to about 35% phosphoric acid. In another preferred embodiment, the composition contains 0% phosphoric acid.

In an embodiment, the compositions of the present invention contain from about 30 to about 40% ADPODS. Preferably, the composition contains from about 30 to about 35% ADPODS.

In a preferred embodiment, the compositions contain from about 10% to about 12% of the fatty acids mixture, about 20% L(+)-lactic acid, about 35% phosphoric acid, and about 35% ADPODS. In a more preferred embodiment, the fatty acids mixture is about 58% C9 fatty acids, about 25% C10 fatty acids, and about 17% C12 fatty acids.

In yet another embodiment, the invention is directed to a ready to use antibiotic cleaner comprising from about 0.02 to 0.2% C9 or C9-C10-C12 fatty acids, 0.5 to 2% L(+)-lactic acid, and from about 0.5 to about 4% C8 to C16 mono- and/or di-alkyldiphenyloxide disulfonate (ADPODS) or fatty alcohol ethoxylate surfactants. This embodiment can contain an essesntial oil. Examples of essential oils include D-limonene, thymol, pinene, clove, rosemary, geraniol, eucalyptus and lemongrass oils. This embodiment may also include a food flavoring. Examples of food flavorings suitable for this embodiment include cinnamic, 4-methyl octanoic or 5-decenoic acid.

Alkyl alcohol ethoxylate nonionic surfactants such as C18 fatty alcohol ethoxylate can also be included in ready to use antibiotic cleaners to improve solubilizing, foaming and cleaning power.

The invention is also directed to methods of using the compositions of the present invention for sanitizing surfaces.

Soluble and stable MEC formulations can be diluted with water to give clear micro-emulsions (ME) of free fatty and hydroxyl acid mixtures which are highly active in hard, cold or organic-load water and can be used in disinfecting and cleaning food or non-food contact surfaces for public health protection and food safety. Stable ME formulation of fatty and hydroxyl carboxylic acid mixtures with essential oil or food flavoring agent can be readily used as consumer antimicrobial cleaner.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

As used herein, “MRLs” refer to the maximum residue limit, or maximum residue levels or tolerances, which are a legally enforceable definition of the maximum concentration of pesticide residues that are allowed on an agricultural commodity at the point of market. MRLs are typically measured in parts per million (ppm). It is important that the products used to clean the equipment used to process agricultural commodities do not leave residues on the commodities.

“Formulation” and “composition” are used in this application interchangeably.

The term “effective amount” means the amount of the formulation that will provide the desired effect on the surface that is being treated. The “effective amount” will vary depending on the formulation concentration, the type of surface being treated, and the result desired, among other factors. Thus, it is not always possible to specify an exact “effective amount.” However, an appropriate “effective amount” in any individual case may be determined by one of ordinary skill in the art.

The following examples are intended to illustrate the present invention and to teach one of ordinary skill in the art how to make the formulations of the invention. They are not intended to be limiting in any way.

### EXAMPLES

### Example 1

Applicant tested liquid fatty acids mixtures to determine cold temperature stability. These tests were conducted using standardized storage stability tests known by those of skill in the art. The results can be seen below in Table 1.

TABLE 1
Cold Solubility Studies on Commercial Fatty Acids Mixtures (% w/w)

| | C8 | C9 | C10 | C12 | C8-C9-C10 | C9-C10-C12 |
|---|---|---|---|---|---|---|
| | (98%) | (95%) | (98%) | (98%) | (30/50/20%) | (58/25/17%) |
| Titer Point, C. | 14-16 | 8-11 | 28-32 | 41-42 | — | — |
| 4 C. Storage | | | | | | |
| 1 day | Crystallized | Crystallized | Soild | Solid | Liquid | Liquid |
| 1 week | — | — | — | — | Liquid | Liquid |

It was unexpectedly discovered that cold tolerant C8-C9-C10 fatty acids or C9-C10-C12 fatty acids liquid mixtures can be obtained from combination of commercial 30% C8, 50% C9 and 20% C10 or 58% C9, 25% C10 and 17% C12 fatty acids (by weight) in the absence of solvent or surfactant as shown in Table 1.

Both fatty acids mixtures, C8-C9-C10 fatty acids and C9-C10-C12 fatty acids, remain liquid at 4 degrees Celsius in storage for at least a week. The commercial C8, C9, C10 and C12 fatty acids all were solid or formed crystals after only one day.

### Example 2

Applicant tested mixtures the preferred fatty acids mixtures with C8 to C16 mono- and di-alkyldiphenyloxide disulfonate (ADPODS) surfactants, fermentation derived L(+)-lactic acid (2-hydroxy propanoic acid), and food-grade phosphoric acid adjuvant to determine their effect on stability. The results can be seen below in Table 2.

TABLE 2
10% C8-10 and C8-9-10 Fatty Acids
Micro-Emulsion Concentrates (MEC)

| Ingredients, wt % | 1 | 2 | 3 | 4 | 5 |
|---|---|---|---|---|---|
| C9 Fatty Acids | 5.0 | 5.0 | 5.0 | — | 2.0 |
| C8-10 Fatty Acids | 5.0 | 5.0 | 5.0 | 10.0 | 8.0 |
| (60/40) | | | | | |
| C8-16 ADPODS | 35.0 | 35.0 | 35.0 | 30.0 | 30.0 |
| L-lactic acid (88%) | 50.0 | 20.0 | — | 50.0 | 50.0 |
| Propanoic Acid (99%) | — | — | 20.0 | — | — |
| Phosphoric acid (75%) | — | 35.0 | 30.0 | — | — |
| DI water | 5.0 | — | 5.0 | 10.0 | 10.0 |
| 4 C. storage/1 week | Soluble | Soluble | Soluble | Soluble | Soluble |
| 0.2% Dilution (500 | Soluble | Soluble | Soluble | Crystals | Soluble |
| ppm water hardness | | | | | |
| and 4 C./24 hr) | | | | | |

Applicant unexpectedly discovered that the mixtures of C8 to C16 mono- and di-alkyldiphenyloxide disulfonate (ADPODS) surfactants have a high solubilizing power for the 5 to 15% C8-C9-C10 fatty acids or C9-C10-C12 fatty acids mixtures in MEC formulations or use water dilutions (ME) when mixed with L(+)-lactic acid or phosphoric acid. Several clear and stable 10% C8-C9-C10 MEC formulations were developed and displayed no phase separation (oil) fatty acids at 4 degrees Celsius or 54 degrees Celsius storage conditions. In 0.1 and 0.2% use dilutions of 500 ppm water hardness, of the MEC dilutions 1, 2, 3 and 5 gave clear and soluble solutions (ME) and showed no crystallization of fatty acids mixtures at 4 degrees Celsius after 24 hours standing.

At least 20% L-lactic acid (88%) or propanoic acid (99%) is required to prevent phase separation of MEC formulations. However, the 0.2% dilution of MEC formulation 4 (similar to that of the commercial product Mandate^{TM}) showed crystallization at 4 degrees Celsius standing (see Table 2).

### Example 3

Applicant tested MEC formulations 1-3 for their bacterial efficacy. The MEC formulations were diluted to 0.1%, 0.2% or 0.35% and subjected to water temperatures of 25 or 4 degrees Celsius. The water had a hardness of 342 ppm. The bacteria, S. aureus, E. coli, and P. aeruginosa were exposed for 30 or 60 seconds. MEC formulation 2 was tested after 9 days of storage at 54 degrees Celsius. The results are below in Table 3.

TABLE 3
Bacterial Efficacy, Temperature and Storage Stability Studies
30 or (60) sec exposure time and 342 ppm water hardness

| | | | % Kill | | |
|---|---|---|---|---|---|
| MEC | | Water | S. | E. | P. |
| Formulation | Dilution | Temp. C. | aureus | coli | aeruginosa |
| 1 | 0.1% | 25 C. | 93.644 | 95.880 | — |
| | 0.2% | 25 C. | 99.999 | 99.998 | — |
| 2 | 0.1% | 25 C. | 99.800 | 99.659 | — |
| | 0.1% | 25 C. | 99.999 | 99.999 | — |
| | | (60 sec) | | | |
| | | or 4 C. | | | |
| | | (60 sec) | | | |
| | 0.35% | 25 C. | — | — | 99.999 |
| 54 C./ | 0.1% | 25 C. | 99.974 | 99.999 | — |
| 9 days | | | | | |
| storage | | | | | |
| 3 | 0.1% | 25 C. | 97.972 | 95.533 | — |

Applicant found that the MEC formulation 2 was still active after 9 days storage at 54 degrees Celsius in an accelerated stability test. The MEC formulation 2 containing L-lactic and phosphoric acid was more active than MEC formulation 1 (L-lactic acid alone) or MEC formulation 3 (propanoic and phosphoric acid combinations). The MEC formulation 2 achieved a 99.999% kill rate against S. aureus and E. coli with a 60 second exposure time at 100 ppm of C8-C9-C10 free fatty acids and a 4 degree Celsius water temperature. MEC formulation 2 can also control P. aeruginosa at 350 ppm free fatty acids. Accordingly, MEC formulation 2 with 20% L- lactic acid (88%) formulation is more active than MEC formulation 3 with 20% propanoic acid (99%) formulation.

C8 to C16 ADPODS surfactants are excellent solubilizing or cleaning agent and have low mammalian toxicity. The 0.1 to 0.2% high dilution rate by w/w and PH 2.5 use solution of MEC formulation 2 will give a cost effective acid disinfecting/cleaning product. MEC formulation 1 containing only L-lactic acid could also be useful for PH sensitive surfaces such as postharvest fruits and vegetables or for household or hospital disinfecting products that are desired to be phosphate free. Further, MEC formulations 1 and 2 have the pleasant smell of coconut.

### Example 4

Mammalian toxicity studies were performed on MEC formulation 2. The mammalian toxicity studies demonstrated that MEC formulation 2 is non-toxic in a rat acute test (LD50=5840 mg/kg weight). Also, there was no skin irritation in a rabbit dermal study at 0.1% (1000 ppm) dilution rate. Accordingly it was determined that MEC formulation 2 was a safe formulation for users.

### Example 5

Applicant tested MEC formulation 4 and MEC formulation 5 for the kill rate of E. coli and S. aureus at 25 degrees Celsius when diluted. The results are below in Table 4.

TABLE 4
Comparison of Joint Action of C8-C10 and C8-
C9-C10 Combinations With Interference Agents*

| | |
|---|---|
| MEC | % Kill* |

| formulation | Dilution | Water Temp | E. coli | S. aureus |
|---|---|---|---|---|
| 4 | 0.1% | 25 C. | 99.999 | 99.990 |
| | 0.05% | 25 C. | 99.900 | — |
| 5 | 0.1% | 25 C. | 99.999 | 99.999 |
| | 0.05% | 25 C. | 99.999 | — |

*Interference agents: 0.3% BSA (bovine serum albumin) organic-load and 342 ppm Ca/Mg hard water were employed in testing. Neutralizers: 1% Tween 80 and 0.5% Lecithin and 0.5% Na₂S₂O₃ or Na₂HPO4 were added after 2-4 minutes mixing to stop the kill. (Refer to China disinfection product testing specifications)

Applicant found that the 10% C8-C9-C10 mixtures of MEC formulation 5 at 0.05 or 0.1% dilution were more active than the 10% C8-C10 mixtures of MEC formulation 4 to give a 99.999% kill rate against E. coli (5-log reduction) in the Chinese standard disinfectant test with interference agents. Further, no crystallization occurred in cold water. The high killing power at 0.05% dilution demonstrates the synergistic combination of C8-C9-C10 fatty acids at 50 ppm dosage.

### Example 6

Applicant tested MEC formulation 2 by subjecting to the Chinese standard fungicidal and virucidal tests as required for public health antimicrobial product. These tests are well known by those of skill in the art. The results can be seen below in Tables 5 and 6.

TABLE 5
Public Health Fungal Efficacy Test Result

| MEC | | | % Kill |
|---|---|---|---|
| Formulation | Dilution | Water Temp. C. | Candida albicans* |
| 2 | 0.35% | 25 C. | 99.999 |

*Candida albicans (ATCC 10231, the sixth to eighth generation) Interference agents: 0.3% BSA and 342 ppm Ca/Mg hard water and 2 minutes contact time.

TABLE 6
Public Health Virus Efficacy Test Result

| MEC | | | % Kill |
|---|---|---|---|
| Formulation | Dilution | Water Temp. C. | PV-1* |
| 2 | 0.35% | 20 C. | >99.99 |

*Virus name: Poliovirus strain PI/LS-C (PV-1); Host cells: RD cell Virus inactivation test (Quantitative Suspension Method): 10 min TCID50 > 4.0 or 99.99% control is acceptable.
(Refer to China disinfection product testing specifications)

Applicant found that MEC formulation 2 at a 0.35% dilution rate (350 ppm of C8-C9-C10 free fatty acids) passed the Chinese standard fungicidal and virucidal tests that are required for public health antimicrobial products.

This further supports Applicant's assertion that MEC formulations 1 and 2 are very safe and have low toxicity as a disinfectant and cleaner for food and non-food surfaces as well as protection against public or animal health diseases. In addition, MEC formulation 1 contains no phosphate and is especially “environmentally friendly.”

### Example 7

Applicant also developed high-potency and cold stable MEC formulations with 12% C8 fatty acids, C9-C10 fatty acids and/or C12 fatty acids or C9 fatty acids, C10 fatty acids and C12 fatty acids and L-lactic acid mixtures as shown in Table 7 below.

TABLE 7
High-Potency MEC Formulations of 12% Fatty Acid Mixtures

| Ingredients, wt % | | HP MEC 1 | HP MEC 2 | HP MEC 3 |
|---|---|---|---|---|
| C8-16 ADPODS | | 30.0 | 30.0 | 30.0 |
| C8-10 Fatty Acids | | 5.0 | — | 5.0 |
| C9 Fatty Acids | | 5.0 | 7.0 | 7.0 |
| C10 Fatty Acids | | — | 3.0 | — |
| C12 Fatty Acids | | 2.0 | 2.0 | — |
| L-lactic acid (88%) | | 55.0 | 55.0 | 55.0 |
| DI water | | Balance | Balance | Balance |
| Bacterium | Dilution | % Kill* at 25 C. and 5 C. | | |
| E. coli | 0.2% | 99.999 | 99.999 | 99.999 |
| | 0.1% | 99.999 | 99.999 | 99.999 |
| | 0.2% at 5 C. | 99.999 | 99.999 | 99.999 |
| S. aureus | 0.2% | 99.999 | 99.999 | 99.999 |
| | 0.1% | 99.999 | 99.998 | 99.997 |
| | 0.2% at 5 C. | 99.996 | 99.997 | 99.999 |

*Interference agents: 0.3% BSA and 342 ppm Ca/Mg hard water.

Applicant found that these formulations had high killing power at 0.1% or 1000 fold dilution by weight. These formulations can be obtained with fatty acids mixtures in the present of organic and inorganic interference agents after 1 to 4 minutes contact time. The formulations also exhibit good activity at 0.2% dilution in 5 degrees Celsius water. The addition of C12 fatty acids can enhance the S. aureus kill rate and reduce foaming for clean-in-place applications on food processing equipment.

### Example 8

Applicant developed ready to use micro-emulsion formulations comprising C9, ADPODS, and L-lactic acid. These products can also contain essential oil fragrances such as D-limonene or food flavoring agents. Further, the products can contain alkyl alcohol ethoxylate nonionic surfactants such as C18 fatty alcohol ethoxylated. These formulations and their kill rates can be seen below in Table 8.

TABLE 8
Ready To Use C9 Free Fatty Acids Micro-emulsion
Formulations and Their Antibacterial Activity

| Ingredients, wt % | ME 1 | ME 2 | ME 3 | ME 4 |
|---|---|---|---|---|
| C8-16 ADPODS | 2.2 | 2.2 | 2.2 | 2.2 |
| C9 Fatty Acids | 0.1 | 0.05 | 0.1 | — |
| L-Lactic acid (88%) | 1.0 | 1.0 | 1.0 | 4.5 |
| D-limonene | — | — | 0.1 | — |
| Alkyl ethoxylate | — | 0.7 | — | — |
| DI water | Balance | Balance | balance | balance |

| | |
|---|---|
| Bacterium | % Kill* |

| | | | | |
|---|---|---|---|---|
| E. coli | 99.999 | 99.999 | 99.999 | 99.999 |
| S. aureus | 99.999 | 99.999 | 99.999 | 99.999 |

*With interference agents and 30 sec contact time.

Clear ME formulations containing 0.05 to 0.1% C9 fatty acids and 1% L-lactic acid can be obtained and packed for a RTU antimicrobial cleaner (such as a product commercialized in a bottle with a trigger spray nozzle) or other health care products. The RTU formulations are cost-effective and as efficacious as other commercially available and registered products.

1. A cold temperature stable micro emulsion concentrate composition comprising:
a. from about 5 to about 15% by weight of an alkyl fatty acids mixture,
wherein the fatty acids mixture consists of
from about 20 to about 80% by weight C8 fatty acids,
from about 20 to about 80% by weight C9 fatty acids,
from about 10 to about 50% by weight C10 fatty acids, and
from about 0 to about 30% by weight C12 fatty acids;
b. from about 20 to 60% by weight L(+)-lactic acid and/or from about 0 to about 40% by weight phosphoric acid; and
c. from about 20 to about 40% by weight C8 to C16 mono- and/or di-alkyldiphenyloxide disulfonate (ADPODS) surfactants.

2. The composition of claim 1 wherein the fatty acids mixture consists of
from about 20 to about 40% by weight C8 fatty acids,
from about 40 to about 60% by weight C9 fatty acids,
from about 10 to about 30% by weight C10 fatty acids, and
from about 0 to about 20% by weight C12 fatty acids.

3. The composition of claim 2 wherein the composition comprises from about 8 to about 12% by weight of the fatty acids mixture.

4. The composition of claim 1 comprising from about 20 to about 50% by weight L(+)-lactic acid.

5. The composition of claim 1 comprising from about 30 to about 40% by weight phosphoric acid.

6. The composition of claim 1 comprising from about 30 to about 40% by weight ADPODS.

7. The composition of claim 1 comprising about from about 10% to about 12% by weight of the fatty acids mixture, about 20% by weight L(+)-lactic acid, about 35% by weight phosphoric acid, and about 35% by weight ADPODS.

8. The composition of claim 7 wherein the fatty acids mixture is about 30% by weight C8 fatty acids, about 50% by weight C9 fatty acids, and about 20% by weight C10 fatty acids.

9. The composition of claim 1 that is diluted with water to form a ready to use product.

10. A cold temperature stable micro emulsion concentrate composition comprising:
a. from about 5 to about 15% by weight of an alkyl fatty acids mixture,
wherein the fatty acids mixture consists of
from about 20 to about 80% by weight C9 fatty acids,
from about 10 to about 50% by weight C10 fatty acids, and
from about 10 to about 30% by weight C12 fatty acids;
b. from about 20 to 60% by weight L(+)-lactic acid or from about 0 to about 40% by weight phosphoric acid; and
c. from about 20 to about 40% by weight C8 to C16 mono- and/or di-alkyldiphenyloxide disulfonate (ADPODS) surfactants.

11. The composition of claim 10 wherein the fatty acids mixture consists of
from about 50 to about 60% by weight C9 fatty acids,
from about 20 to about 30% by weight C10 fatty acids, and
from about 10 to about 20% by weight C12 fatty acids.

12. The composition of claim 11 wherein the composition comprises from about 8 to about 12% by weight fatty acids mixture.

13. The composition of claim 10 comprising from about 20 to about 50% by weight L(+)-lactic acid.

14. The composition of claim 10 comprising from about 30 to about 40% by weight phosphoric acid.

15. The composition of claim 10 comprising from about 30 to about 40% by weight ADPODS.

16. The composition of claim 10 comprising from about 10% to about 12% by weight fatty acids mixture, about 20% by weight L(+)-lactic acid, about 35% by weight phosphoric acid, and about 35% by weight ADPODS.

17. The composition of claim 16 wherein the fatty acids mixture is about 58% by weight C9 fatty acids, about 25% by weight C10 fatty acids, and about 17% by weight C12 fatty acids.

18. The composition of claim 17 that is diluted with water to form a ready to use product.

19. A ready to use antibiotic cleaner comprising from about 0.02 to 0.2% by weight C9 fatty acids or C9-C10-C12 fatty acids, 0.5 to 2% by weight L(+)-lactic acid, and from about 0.5 to about 4% by weight C8 to C16 mono- and/or di-alkyldiphenyloxide disulfonate (ADPODS) or fatty alcohol ethoxylate surfactants, optionally an essential oil, and optionally a food flavoring.
